(19) United States
(12) Patent Application Publication
(10) Pub. No.: US 2007/0190216 A1
(43) Pub. Date: Aug. 16, 2007

(54) Method for the production of pasta, pasta obtainable according hereto and system for carrying out said method

(75) Inventor: Werner Seiler, Zuberwangen (CH)

Correspondence Address: HESLIN ROTHENBERG FARLEY & MESITI PC, 5 COLUMBIA CIRCLE, ALBANY, NY, 12203, US

(73) Assignee: BUHLER AG, Uzwil (CH)

(21) Appl. No.: 10/598,105

(22) PCT Filed: Dec. 27, 2004
(86) PCT No.: PCT/CH04/00755

§ 371 Date: Aug. 17, 2006

(30) Foreign Application Priority Data
Feb. 19, 2004 (DE) 10 2004 008 443.2
Mar. 12, 2004 (DE) 10 2004 012 589.9

(51) Int. Cl. A23L 1/16

(52) U.S. Cl. 426/557

(57) ABSTRACT

The invention relates to the production of pasta, particularly pasta made of gluten-free raw materials such as flour and/or semolina based on maize, rice, millet or barley or starch, wherein the method comprises the following steps: a) preparation of a raw material-dry mixture; b) incorporation of water into the raw material dry mixture while the raw material is moved in order to obtain a dough or a moistened raw material mixture; c) incorporation of steam into the dough, during which the dough or moistened raw material mixture is moved; d) forming of the dough thus obtained in order to create defined dough objects; and e) drying of the formed dough objects in order to form pasta.

The invention relates to a method and a device for manufacturing pastas, in particular out of gluten-free raw materials, e.g., flour and/or semolina based on corn, millet or barley, or out of starch.

Pastas based on corn, rice or made using other gluten-free raw materials are known in the art. However, as opposed to wheat or rye, since gluten-free raw materials contain no gluten that must be present as an adhesive framework in the dough for manufacturing pastas, corn flour or corn semolina, similarly to rice flour, cannot be easily processed into corn or rice pastas. Therefore, wheat flour, for example, is added to the corn flour or rice flour used for this purpose to supply gluten. As an alternative, adhesively acting modified starches, e.g., alpha starch, or egg yolks, can also be added to the corn flour to impart the missing adhesive properties to the gluten-free raw materials. The mechanical or rheological properties of dough are influenced by its gluten and starch share. The adhesive framework of the dough primarily shapes the elastic component of the viscoelastic dough, while the (native or modified) starch of the dough primarily shapes the viscous component of the dough.

The reasons for manufacturing pastas based on gluten-free raw materials include the fact that more and more people suffer from celiac disease, an allergy to gluten, but also the desire to be able to manufacture pastas based on the locally available raw materials in regions of the world where predominately corn, rice, millet or other local raw materials flourish, and not wheat or rye.

Therefore, health and/or economic considerations often make it impossible to add wheat or rye to gluten-free raw materials as the supplier of gluten.

Known from EP 0 792 109 B1 is the manufacture of pastas, wherein no ingredients other than corn flour and water are used. Instead of adding what flour, alpha starch or egg yolk as described further above, the corn flour is in a cooked or precooked state before mixed with water and shaped in the method in EP 0 792 109 B1. Therefore, the corn flour was at least partially modified (precooked, gelatinized) and dried prior to pasta production. When it is subsequently again mixed in with water, kneaded and shaped to manufacture corn pastas, the previously modified share of the corn starch provides the adhesiveness necessary for dough and pasta production.

This method does yield pure corn pastas made only of corn flour and water. However, the disadvantage to the method is that water must again be added to the corn flour pretreated via cooking or precooking in order to manufacture the corn pastas, but had been at least partially removed after the pretreatment. The prior removal and subsequent renewed addition of water to the corn flour is energy intensive, and drives up the costs of the method.

Therefore, the object of this invention is to provide a method for manufacturing pastas, in particular based on gluten-free raw materials, which offers an efficient energy use and can do without wheat or rye flour as the gluten supplier, or in which pasta quality can be increased even if gluten-containing raw materials are used.

This object is achieved based on the invention via the method according to claim 1 or the device according to claim 17.

The method according to the invention for manufacturing pastas, in particular out of gluten-free raw materials, e.g., flour and/or semolina based on corn, rice, millet or barley, or out of starch, involves the following steps:
a) Generating a raw material dry mixture;
b) Metering water into the raw material dry mixture with this raw material in motion, thereby producing a dough or moistened raw material mixture;
c) Metering vapor into the dough with the dough or moistened raw material in motion;
d) Molding the thusly obtained dough into defined dough structures; and
e) Drying the molded dough structures into pastas.

Metering in both vapor and water makes it possible to achieve a specific gelatinization of the starch contained in the raw materials, wherein the raw materials can also be gluten-free.

This is necessary when using gluten-free raw materials, since no adhesive framework can be created therein during dough manufacture.

It has proven particularly advantageous to initially meter water into the raw material dry mixture with this raw material in motion, thereby yielding a dough or moistened raw material mixture (step b), and to subsequently meter vapor into the dough with the dough or moistened raw material mixture is in motion (step c). This makes it possible to specifically modify or gelatinize the starch.

The raw material dry mixture is best moved in step b) using a mixer, in particular a two-screw mixer, wherein the movement of the dough in step c) preferably takes place in a mixer, in particular a two-screw mixer. Such a mixer represents an ideal reactor for starch modification in a continuous procedure. The time of exposure to the vapor in the mixer during step c) should range from about 10 s to 60 s, preferably 20 s to 30 s.

As an alternative, the moistened raw material mixture in step c) can also be moved on a conveyor belt, in particular a belt evaporator, wherein the vapor exposure time in step c) here should range between 30 s and 5 min.

In a particularly advantageous embodiment of the method according to the invention, at least one additive is metered into the raw material mixture. This additive can be metered into the raw material dry mixture in step a), but can also be metered into the raw material dry mixture in step b).

A monoglyceride, diglyceride, hardened fat or a hydrocolloid is preferably used as the additive. This type of additive is physiologically safe from a nutritional standpoint, but markedly improves the quality features of the pastas manufactured according to the invention, as will be described below.

When using a mixer or two-screw extruder for metering in water in step b) and metering in vapor in step c), evaporation takes place in the mixer at a working pressure of 2 bar.

Regardless of whether a two-screw extruder or a belt evaporator is used during evaporation in step c), the vapor is best added in step c) at an initial vapor pressure of 1 bar to 10 bar, wherein vapor is preferably metered in step c) at an initial vapor temperature of 100° C. to 150° C., in particular 100° C. to 120° C. It is particularly advantageous if the water previously metered in step b) has a temperature of 30° C. to 90° C., in particular of 75° C. to 85° C.

In this case, one must make sure that the dough obtained in step b) has a water content of 20% to 60%, in particular of 38% to 45%, or that the mass ratio of the metered water quantity to the metered vapor quantity ranges from 5:1 to 1:1, in particular from 4:1 to 2:1, most preferably measuring 3:1.

The system according to the invention for manufacturing pastas out of gluten-free raw materials, in particular for implementing the method described further above, has the following features:
A mixing device for generating a raw material dry mixture;
A water metering device for metering water into the raw material dry mixture;
A vapor metering device for metering vapor into the moistened raw material mixture;
A raw material moving device for moving the raw material dry mixture and moistened raw material mixture;
A molding device for molding the dough obtained from the raw material mixture into defined dough structures; and
A pasta drying device for drying the molded dough structure into pasta.

The raw material moving device can have a mixer, in particular a two-screw mixer, or a conveyor belt, in particular a belt evaporator, as already explained further above.

In a particularly advantageous embodiment, the mixer is a mixing kneader with a casing, a raw material supply section, a raw dough discharge section, along with at least two cooperating working shafts that extend in a conveying direction or axial direction from the raw material supply section to the raw dough discharge section within the casing, which accommodate mixing and kneading elements, along with force-conveying elements. The area of the mixing kneader cavity upstream from its raw dough discharge section can have a peristaltic dough kneading area, which has at least a respective narrowing axial cavity area, in which the free cross sectional area of the cavity between the surface of the working shafts and the inner wall of the casing as measured perpendicular to the axial direction decreases from a region with a large free cross sectional area to a region with a small free cross sectional area along the axial direction. In addition, the mixing kneader can have an area upstream from its peristaltic dough kneading area for mixing and conveying dough, in which axial areas with conveying screws and axial areas with mixing blocks are arranged on the working shafts consecutively along the conveying direction. The mixing kneader preferably has another area upstream from its peristaltic dough kneading area for tumbling or working the dough, in which tumbling and working screws are arranged on the working shafts along the conveying direction, with passages extending in an axial direction being located in their screw webs, establishing a fluidic connection between adjacent windings of a spiral. These passages can be arranged like a gap at the comb of the screw webs, or like a window between the core and the comb of the screw webs. In addition, the surface of the working shafts and/or that of the inner wall of the casing can be provided with an anti-adhesive layer, preferably made out of Teflon, in the peristaltic dough kneading area.

These equipment-related measures in combination with the method-related features mentioned above help to optimize the pastas obtained in this way. Specifically, the starch grains made partially swellable are optimally homogenized via the rheologically induced flow characteristics through compression and relaxation with a gentle flow shearing in the compaction pressure area for molding the pastas. This soft homogenization yields a dough mass that is very uniform in terms of dough temperature, and in the final analysis results in a uniform mass flow in addition to starch grain preservation.

The raw material moving device can also have a classic dough press with an upstream mixing trough situated downstream from the two-screw mixer.

The raw material moving device preferably has a single-screw extruder situated immediately downstream from the two-screw mixer.

In another advantageous embodiment, the single-screw extruder has a casing, a raw dough supply section, a dough discharge section, as well as a working shaft that extends in a conveying direction or axial direction from the raw material supply section to the raw dough discharge section within the casing, and accommodates force-conveying elements. The cavity of the single-screw extruder can have a peristaltic dough kneading area upstream from its dough discharge section, which has at least one respective narrowing axial cavity area, in which the free cross sectional area of the cavity between the surface of the working shaft and the inner wall of the casing as measured perpendicular to the axial direction decreases from a region with a large free cross sectional area to a region with a small free cross sectional area along the axial direction.

In order to achieve the process temperatures mentioned above, the mixing kneader preferably has a casing that can be heated to between 40° C. and 100° C., preferably between 50° C. and 75° C.

In terms of the continued temperature progression of the method, it is advantageous for the single-screw extruder to have a casing that can be heated to between 20° C. and 60° C., preferably to between 40° C. and 50° C., wherein it is especially advantageous for the downstream molding device to have a press-molding head that can be heated to between 30° C. and 60° C., preferably to between 40° C. and 50° C.

The method according to the invention and device according to the invention make it possible to manufacture a gluten-free pasta product characterized in that the starch contained in the product swells from 50% to 100%, in particular 75% to 85%.

The starch grains contained in the product are here for the most part intact. In particular, 60% to 80% of the starch grains contained in the product are intact or have not burst. This is the precondition for a low cooking loss, and a low sliminess while cooking the pastas according to the invention. Therefore, even though there is no gluten present, the pasta product according to the invention exhibits a cooking loss of less than 5% of the dry mass, and can hence indeed be compared to pastas based on durum wheat.

In addition, the pasta product according to the invention has a fat content of less than 1% of the dry mass. While it can consist of gluten-free raw materials like flour and/or semolina based on corn, rice, millet or barley, or of starch, all other gluten-free raw materials are conceivable. It can be processed into dry or fresh pastas.

In the case of fresh pastas, the drying step e) is not carried out. Instead, the fresh pastas manufactured in this way can be precooked, blanched or pasteurized, and subsequently cooled or frozen, exhibiting a water content that exceeds 20%.

As in the case of conventional gluten-containing pastas, the pastas according to the invention can be molded into short-cut pastas, e.g., shells, dumpling, tubes, etc., or into long pastas, e.g., spaghetti, lasagna or nidi (nester), etc.

Additional advantages, features and possible applications of the invention may be gleaned from the following description of two exemplary embodiments based on the attached drawing, which is not to be regarded as limiting in any way. Shown on:

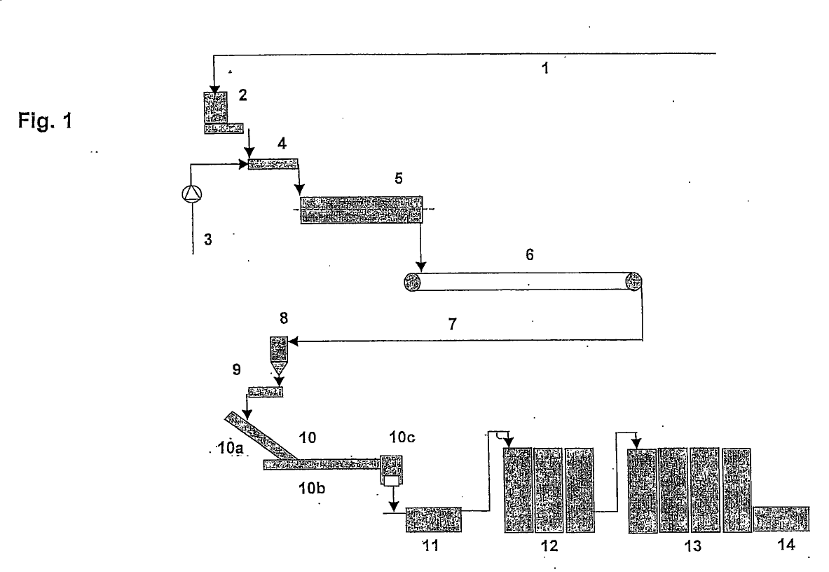

FIG. 1 is a diagrammatic view of the first exemplary embodiment of this invention, and

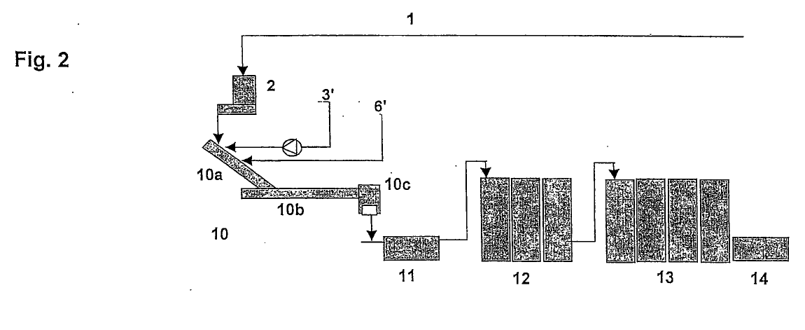

FIG. 2 is a diagrammatic view of the second exemplary embodiment of this invention.

FIG. 1 is a schematic diagram of a first exemplary embodiment of the system according to the invention for implementing the method according to the invention for the manufacture of gluten-free pastas, e.g., corn pastas. A pneumatic conveying line 1 extends from a mill (not shown) to a drying/metering device 2. Any raw material dry mixture can be supplied to the drying/metering device 2 via the pneumatic conveying line 1. The raw material dry mixture can be mixed in the mill in advance. An additive metering device (not shown) can be provided for the dry metering of an additive in the mill or after the metering device 2. A rapid mixer 4 is placed downstream from the dry metering device 2. A liquid metering device 3 is used to meter water and, if needed, an additive in liquid form t the dry mixture in the rapid mixer 4. The finished mixture prepared in this rapid mixer 4 is routed to a mixing trough 5 of the pasta system. A belt evaporator 6 is placed downstream from the mixing trough 5. The finished mixture prepared in the rapid mixer then passes tot his belt evaporator 6, where the finished mixture is evaporated. The belt evaporator 6 is connected by an additional pneumatic conveying line 7, a separator 8 in which the conveyed air is separated from the product, and a vibrating feeding tube 9 to a pasta press 10, which has a mixer/kneader in the form of a two-screw extruder 10a, a press in the form of a single-screw extruder 10b, and a press-molding head 10c. A shaking pre-dryer 11, pre-dryer 12, final dryer 13 and cooler 14 are situated downstream from the pasta press 10.

Such a liquid metering is required at the beginning of the process for manufacturing corn pastas. The metered water is intended to slightly pre-swell the cornstarch contained in the corn. To this end, the water is metered in at a temperature of between 60° C. and 80° C. The elevated water temperature is also necessary to accelerate the penetration of water into the corn.

The metered components, mixed corn and water, are intensively mixed together in the rapid mixer 4, so that the metered water is distributed over the entire surface of the corn. A superficial starch modification can already be introduced with the hot water, causing the corn particles to slightly agglomerate.

The maximum possible retention time in the mixing trough 5 permits the water to penetrate into the corn. This makes it possible to achieve optimum results in the ensuing thermal treatment.

The objective of the evaporating process in the belt evaporator 6 is to partially gelatinize the present starch, or make it swellable.

The starch modification can be adjusted within an evaporation time of 1 min to 5 min, making it possible to also partially affect the chewing consistency of the cooked corn pastas. The belt evaporator operates at an initial evaporation pressure of up to 6 bar, and a working pressure in the evaporator of about 0.5 bar.

The pneumatic conveying line 7 is used to route the cooked product to the pasta press 10 via the separator 8 and vibrating feeding tube. The conveyed air is separated from the product to be conveyed in the separator 8. The vibrating feeding tube 9 ensures a uniform feeding into the mixer/kneader 10a of the pasta press 10.

The pasta press (Buhler Polymatik) must be operated in such a way that the produced quantity of prepared corn is continuously processed. Power-imparting metering takes place at the beginning of the process. The mixer/kneader 10a, the press lob and the press-molding head 10c must be temperature controlled, specifically at least in a range of 50° C. to 70° C. The operating speeds lie within the standard range, and must be formulated accordingly depending on power. The dough moisture fluctuates at around 40% water content.

The corn pastas exit the pasta press (10a, 10b, 10c) with a higher level of dough moisture than traditional short and long goods based on wheat flour. The initial moisture of the products to be dried measures approx. 40%. The shaking pre-dryer 11 is correspondingly designed for production at higher temperatures of about 50° C. to approx. 90° C., preferably of around 75° C.

The drying temperatures and throughput times in the pre-dryer 12 correspond to those in traditional wheat-based products.

Final drying in the final dryer 13 should and can take place at higher temperatures than for the mentioned traditional products, but without negatively influencing the xanthophylls (yellow corn pigments) in the process. Usual temperatures in the final dryer 13 range from about 75° C. to 90° C., depending on the system and its configuration.

The stabilization to room temperature executed in the cooler 14 can take place in the same way as for traditional pastas under the appropriate conditions.

These measures guaranty a final moisture level in the corn pastas according to the invention measuring 11.5% to 12.5% water content.

FIG. 2 is a schematic diagram of a second exemplary embodiment of the system according to the invention for implementing the method according to the invention for the manufacture of gluten-free pastas, e.g., corn pastas. All elements identical or analogous to those in the first exemplary embodiment of FIG. 1 bear the same reference numbers on FIG. 2 as on FIG. 1. Their function is identical or similar to that in the first exemplary embodiment on FIG. 1.

In the first exemplary embodiment on FIG. 1, water followed by vapor is metered into the rapid mixer 4 or belt evaporator 6 before the finished dough mixture (moistened and evaporated raw material mixture) gets into the pasta press 10. By contrast, the water and vapor are metered directly into the pasta press 10, specifically in its mixer/kneader or two-screw extruder 10a. The water is metered directly into the two-screw extruder 10a of the pasta press 10 via the liquid metering device 3′. In like manner, the vapor is metered directly into the two-screw extruder 10a of the pasta press 10 via the vapor metering device 6′. Vapor metering takes place after or downstream from water metering, along the path traversed by the two-screw extruder. Otherwise, the first and second exemplary embodiments mirror each other.

Therefore, the second exemplary embodiment no longer requires the rapid mixer 4, the mixing trough 5, the belt evaporator 6, the second pneumatic line 7, the separator 8 as well as the vibrating feeding tube 9. As a result, the second exemplary embodiment involves a far lower equipment outlay than the first exemplary embodiment.

As opposed to the evaporation process according to exemplary embodiment 1, metering imparts power directly via the pneumatic line 1 to the pasta manufacturing process in the pasta press (Buhler Polymatik).

Essentially the same conditions as in exemplary embodiment 1 apply to liquid metering via the liquid metering device 3.

While the evaporation process according to exemplary embodiment 1 essentially takes place at atmospheric pressure or under a slight overpressure, evaporation in the second exemplary embodiment occurs at a working evaporation pressure of about 2 bar to 5 bar in the two-screw extruder 10a. In order to realize the entire necessary range of starch modification, it is necessary to achieve the desired corn consistency by injecting vapor into the process executed by the mixer/kneader or two-screw extruder 10a. The modification level makes it possible to adjust quality features for the corn pastas with respect to bite, chewing consistency and cooking loss.

Since the partial cooking process takes place in the mixer/kneader 10a, it must be possible to heat the latter up to about 80° C. Hot water and vapor or just hot water make it possible to introduce the required energy into the corn to generate the necessary gluten substitute in the form of starch paste.

The hot water and vapor treatment in the mixer/kneader 10a requires that the system be heated to a range of 50° C. to 70° C. in order to prevent condensate, and in this way optimally achieve dough transport in the screw without slippage or with minimal slippage.

Adjusting the head temperature influences the elasticity and viscosity of the corn dough mass in such a way that no unnecessary shearing forces and pressures arise that might negatively influence the mass flow. Heating to between 50° C. and 65° C. is also necessary in this case.

The drying and stabilizing process can be executed identically to the drying and stabilizing process of the first exemplary embodiment, so that corn pastas with a final moisture level of 11.5% to 12.5% water are also obtained here in the final analysis.

All products are preferably dried with the drying profile depicted below in terms of temperature, moisture and times.

| | Temperature | Moisture | Retention |
|---|---|---|---|
| Zone | (° C.) | (% rh) | time (min) |
| Zone 1 | 30 | 60 | 5 |
| Zone 2 | 60 | 80 | 10 |
| Zone 3 | 80 | 80 | 23 |
| Zone 4 | 82 | 80 | 38 |
| Zone 5 | 88 | 80 | 72 |
| Zone 6 | 88 | 78 | 80 |

1. A method for manufacturing pastas out of gluten-free raw materials, e.g., flour and/or semolina based on corn, rice, millet or barley, or out of starch, wherein the method involves the following steps:
a) Generating a raw material dry mixture;
b) Metering water with a temperature of 30° C. to 90° C., in particular 75° C. to 85° C. into the raw material dry mixture with this raw material in motion, thereby producing a dough or moistened raw material mixture with a water content of 20% to 60%, in particular 38% to 45%;
c) Metering vapor with an initial vapor temperature of 100° C. to 150 C., in particular 100° C. to 120° C., into the dough with the dough or moistened raw material in motion;
d) Molding the thusly obtained dough into defined dough structures; and
e) Drying the molded dough structures into pastas, wherein the mass ratio between the metered water quantity and the metered vapor quantity ranges between 5:1 to 1:1.

2. The method according to claim 1, characterized in that the raw material dry mixture is moved in step b) in a mixer, in particular a two-screw mixer.

3. The method according to claim 1, characterized in that the dough is moved in step c) in a mixer, in particular a two-screw mixer.

4. The method according to claim 3, characterized in that the vapor exposure time in the mixer during step c) measures about 10 s to 60 s, preferably 20 s to 30 s.

5. The method according to claim 1, characterized in that the moistened raw material mixture is moved in step c) on a conveyor belt, in particular a belt evaporator.

6. The method according to claim 5, characterized in that the vapor exposure time during step c) measures 30 s to 5 min.

7. The method according to one of claim 1, characterized in that at least one additive is metered into the raw material mixture.

8. The method according to claim 7, characterized in that the additive is metered into the raw material dry mixture in step a).

9. The method according to claim 7, characterized in that the additive is metered into the raw material dry mixture in step b).

10. The method according to claim 7, characterized in that at least one monoglyceride or one diglyceride or a hardened fat is used as the additive.

11. The method according to claim 1, characterized in that the vapor metered in step c) has a working pressure during evaporation of 2 bar to 5 bar.

12. The method according to claim 1, characterized in that vapor is metered in step c) with an initial vapor pressure of 1 bar to 10 bar.

13. The method according to claim 1, characterized in that the mass ratio of the metered water quantity to the metered vapor quantity ranges from 4:1 to 2:1, most preferably measuring 3:1.

14. A system for implementing a method for the manufacture of pastas out of gluten-free raw materials, in particular for implementing a method according to claim 1, with:
A mixing device for generating a raw material dry mixture;
A water metering device for metering water into the raw material dry mixture;
A vapor metering device for metering vapor into the moistened raw material mixture;
A raw material moving device for moving the raw material dry mixture and moistened raw material mixture;
A molding device molding the dough obtained from the raw material mixture into defined dough structures; and
A pasta drying device for drying the molded dough structure into pasta, characterized in that the vapor can be metered at an initial vapor pressure of 1 bar to 10 bar.

15. The system according to claim 14, characterized in that the raw material moving device has a mixer, in particular a two-screw mixer.

16. The system according to claim 14, characterized in that the raw material moving device has a conveyor belt, in particular a belt evaporator.

17. The system according to claim 15, characterized in that the mixer is a mixing kneader with a casing, a raw material supply section, a raw dough discharge section, along with at least two cooperating working shafts that extend in a conveying direction or axial direction from the raw material supply section to the raw dough discharge section within the casing, which accommodate mixing and kneading elements, along with force-conveying elements.

18. The system according to claim 17, characterized in that the area of the mixing kneader cavity upstream from its raw dough discharge section has a peristaltic dough kneading area, which has at least a respective narrowing axial cavity area, in which the free cross sectional area of the cavity between the surface of the working shafts and the inner wall of the casing as measured perpendicular to the axial direction decreases from a region with a large free cross sectional area to a region with a small free cross sectional area along the axial direction.

19. The system according to claim 17, characterized in that the mixing kneader has an area upstream from its peristaltic dough kneading area for mixing and conveying dough, in which axial areas with conveying screws and axial areas with mixing blocks are arranged on the working shafts consecutively along the conveying direction.

20. The system according to claim 17, characterized in that the mixing kneader preferably has another area upstream from its peristaltic dough kneading area for tumbling or working the dough, in which tumbling and working screws are arranged on the working shafts along the conveying direction, with passages extending in an axial direction being located in their screw webs, establishing a fluidic connection between adjacent windings of a spiral.

21. The system according to claim 20, characterized in that the passages are arranged like a gap at the comb of the screw webs.

22. The system according to claim 20, characterized in that the passages are arranged like a window between the core and the comb of the screw webs.

23. The system according to claim 18, characterized in that the surface of the working shafts and/or that of the inner wall of the casing can be provided with an anti-adhesive layer, preferably made out of Teflon, in its peristaltic dough kneading area.

24. The system according to claim 15, characterized in that the raw material moving device has a dough press with an upstream mixing trough situated downstream from the two-screw mixer.

25. The system according to claim 14, characterized in that the raw material moving device has a single-screw extruder situated immediately downstream from the two-screw mixer.

26. The system according to claim 25, characterized in that the single-screw extruder has a casing, a raw dough supply section, a dough discharge section, as well as a working shaft that extends in a conveying direction or axial direction from the raw material supply section to the raw dough discharge section within the casing, and accommodates force-conveying elements.

27. The system according to claim 26, characterized in that the cavity of the single-screw extruder has a peristaltic dough kneading area upstream from its dough discharge section, which has at least one respective narrowing axial cavity area, in which the free cross sectional area of the cavity between the surface of the working shaft and the inner wall of the casing as measured perpendicular to the axial direction decreases from a region with a large free cross sectional area to a region with a small free cross sectional area along the axial direction.

28. The system according to claim 17, characterized in that the mixing kneader has a casing that can be heated to between 40° C. and 100° C., preferably between 50° C. and 75° C.

29. The system according to claim 25, characterized in that the single-screw extruder has a casing that can be heated to between 20° C. and 60° C., preferably to between 40° C. and 50° C.

30. The system according to claim 14, characterized in that molding device has a press-molding head that can be heated to between 30° C. and 60° C., preferably to between 40° C. and 50° C.

31. The system according to claim 14, characterized in that all steps are monitored, regulated and controlled online during the process.

32. A gluten-free pasta product, in particular one manufactured according to a method based on claim 1, characterized in that the starch contained in the product swells from 50% to 100%, in particular 75% to 85%, wherein the starch grains contained in the product are for the most part intact.

33. The pasta product according to claim 32, characterized in that 60% to 80% of the starch grains contained in the product are intact or have not burst.

34. The pasta product according to claim 32, characterized in that it has a cooking loss of less than 5% of the dry mass

35. The pasta product according to claim 32, characterized in that it has a fat content of less than 1% of the dry mass.

36. The pasta product according to claim 32, characterized in that it is made out of gluten-free raw materials like flour and/or semolina based on corn, rice, millet or barley, or of starch.

37. A method for manufacturing pastas out of gluten-free raw materials, e.g., flour and/or semolina based on corn, rice, millet or barley, or out of starch, wherein the method involves the following steps:
a) Generating a raw material dry mixture;
b) Metering water with a temperature of 30° C. to 90° C., in particular 75° C. to 85° C. into the raw material dry mixture with this raw material in motion, thereby producing a dough or moistened raw material mixture with a water content of 20% to 60%, in particular 38% to 45%;
c) Metering vapor with an initial vapor temperature of 100° C. to 150° C., in particular 100° C. to 120° C., into the dough with the dough or moistened raw material in motion;
d) Molding the thusly obtained dough into defined dough structures; and
e) Drying the molded dough structures into pastas, wherein the mass ratio between the metered water quantity and the metered vapor quantity ranges between 5:1 to 1:1.

38-41. (canceled)
